(19) United States
(12) Patent Application Publication
(10) Pub. No.: US 2021/0209713 A1
(43) Pub. Date: Jul. 8, 2021

(54) METHOD AND APPARATUS FOR PROVIDING A RIDE-HAILING SERVICE BASED ON USER DIABILITY DATA

(71) Applicant: HERE Global B.V., Eindhoven (NL)

(72) Inventors: Haquemobassir IMTIYAZ, Maharashtra (IN); Sanket PALANDE, Maharashtra (IN); Vinish NADAR, Koparkhairane (IN); Danny SAVLA, Maharashtra (IN)

(21) Appl. No.: 16/733,966

(22) Filed: Jan. 3, 2020

(51) Int. Cl. G06Q 50/30; G06F 16/29

(52) U.S. Cl. CPC G06Q 50/30; G06F 16/29

(57) ABSTRACT

An approach is provided for providing a ride-hailing/ride-booking service based on user disability data that minimizes pickup wait time. The approach involves selecting a pick-up location, a drop-off location, or a combination thereof by analyzing map feature data queried from a geographic database of one or more candidate pick-up locations, one or more candidate drop-off locations, or a combination thereof as a function of disability information associated with a user . The approach also involves providing the pick-up location, the drop-off location, or a combination thereof as an output to a user device of the user, a vehicle picking up or dropping off the user, a ride booking service, or a combination thereof .

### BACKGROUND

Ride-hailing services (e.g., cabs, ride-sharing services, etc.) are gaining increasing popularity to the point where many users view them as essential modes of transportation. However, certain segments of users such as users with disabilities or other physical challenges continue to face significant obstacles to using ride-hailing services to book, identify, and complete a ride. Accordingly, service providers face significant technical challenges to providing disabled or physically-challenged users with increased access to ride-hailing or equivalent transportation services.

### SOME EXAMPLE EMBODIMENTS

Therefore, there is a need for providing a ride-hailing service that considers a user's disability (e.g., permanent or temporary disabilities that affects a user's mobility, sight, hearing, etc.) so that a disabled or physically challenged user can independently use the ride-hailing service to book a ride, and then to identify the ride in the field to complete the ride. For example, one approach involves using map data to automatically identify and recommend pick-up and/or drop-off locations that provide for a level of physical accessibility correlated to a user's given disability.

According to one embodiment, a computer-implemented method comprises selecting a pick-up location, a drop-off location, or a combination thereof by analyzing map feature data queried from a geographic database of one or more candidate pick-up locations, one or more candidate drop-off locations, or a combination thereof as a function of disability information associated with a user. The method also comprises providing the pick-up location, the drop-off location, or a combination thereof as an output to a user device of the user, a vehicle picking up or dropping off the user, a ride booking service, or a combination thereof

According to another embodiment, an apparatus comprises at least one processor, and at least one memory including computer program code for one or more computer programs, the at least one memory and the computer program code configured to, with the at least one processor, cause, at least in part, the apparatus to select a pick-up location, a drop-off location, or a combination thereof by analyzing map feature data queried from a geographic database of one or more candidate pick-up locations, one or more candidate drop-off locations, or a combination thereof as a function of disability information associated with a user. The apparatus is also caused to provide the pick-up location, the drop-off location, or a combination thereof as an output to a user device of the user, a vehicle picking up or dropping off the user, a ride booking service, or a combination thereof.

According to another embodiment, a non-transitory computer-readable storage medium carries one or more sequences of one or more instructions which, when executed by one or more processors, cause, at least in part, an apparatus to select a pick-up location, a drop-off location, or a combination thereof by analyzing map feature data queried from a geographic database of one or more candidate pick-up locations, one or more candidate drop-off locations, or a combination thereof as a function of disability information associated with a user. The apparatus is also caused to provide the pick-up location, the drop-off location, or a combination thereof as an output to a user device of the user, a vehicle picking up or dropping off the user, a ride booking service, or a combination thereof.

According to another embodiment, an apparatus comprises means for selecting a pick-up location, a drop-off location, or a combination thereof by analyzing map feature data queried from a geographic database of one or more candidate pick-up locations, one or more candidate drop-off locations, or a combination thereof as a function of disability information associated with a user. The apparatus also comprises means for providing the pick-up location, the drop-off location, or a combination thereof as an output to a user device of the user, a vehicle picking up or dropping off the user, a ride booking service, or a combination thereof

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a ride-hailing/ride-booking service based on user disability data, according to one embodiment;

FIG. 2 is a diagram of the components of a routing platform, according to one embodiment;

FIG. 3 is a flowchart of a process for providing a ride-hailing/ride-booking service based on user disability data, according to one embodiment;

FIGS. 4A through 4E are diagrams of example location-based user interfaces for providing a ride-hailing/ride-booking service based on user disability data, according to one embodiment;

FIGS. 5A through 5C are diagrams of example location-based user interfaces for supporting ride-booking for a blind and mute person, according to one embodiment;

FIG. 6 is a diagram of a geographic database, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal (e.g., handset or vehicle or part thereof) that can be used to implement an embodiment.

### DESCRIPTION OF SOME EMBODIMENTS

Examples of a method, apparatus, and computer program for providing a ride-hailing/ride-booking service based on user disability data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

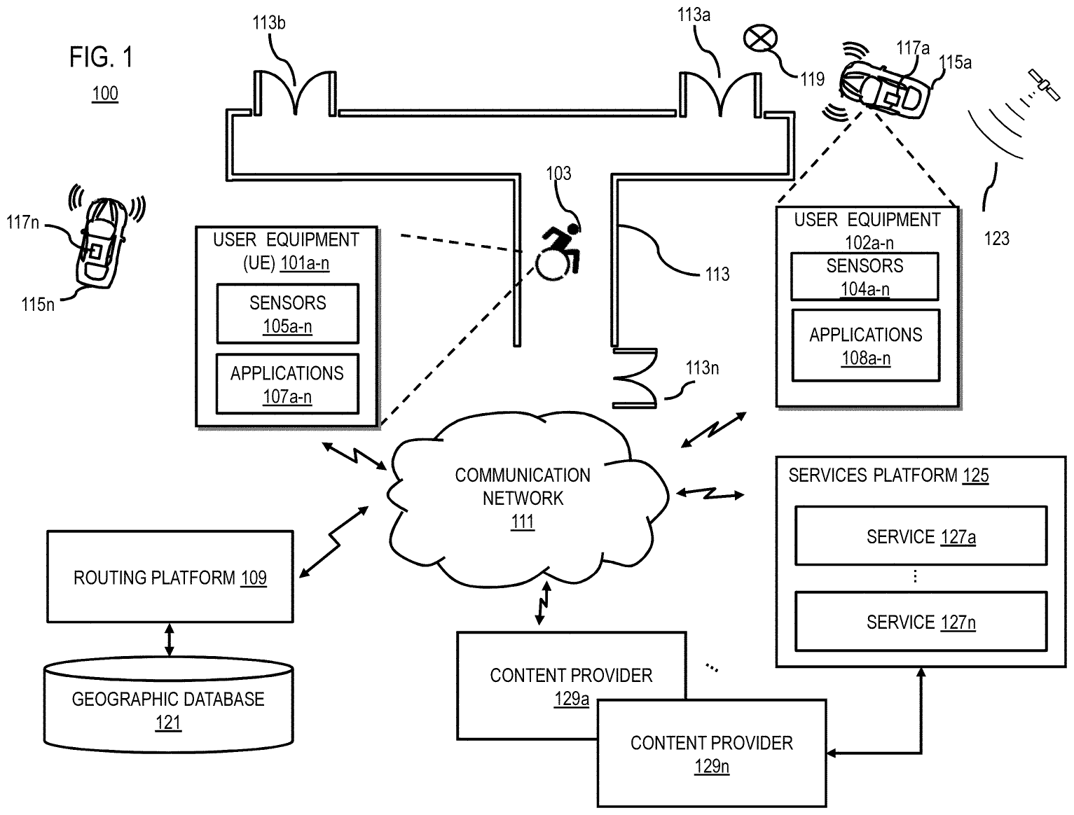

FIG. 1 is a diagram of a system capable of providing a ride-hailing/ride-booking service based on user disability data, according to one embodiment. As discussed above, there historically has been limited to no support for booking and getting rides via a ride-hailing or ride-booking service (used synonymously in the embodiments described herein) for disabled or physically challenged people to use independently by themselves. Consequently, many disabled people have to rely on attendants, helpers, friends, etc. to book and complete a ride (e.g., cab ride, ride-sharing ride, public transport ride, etc.), which potentially limits their mobility. For example, when a user has a disability (e.g., blindness, uses a wheelchair, etc.) and is unfamiliar with suitable locations in the proximity, the user may not know which nearby pick-up and/or drop-off locations are accessible (or more easily accessible) based on the user's given disability.

In general, both users with disabilities and ride-hailing service providers seek to minimize the travel and/or waiting time for the users, or delay in picking up by a ride hailing service driver. However, there generally are a variety of different potential pick-up and/or drop-off locations available in a given area. For example, a large point of interest (POI) (e.g., a shopping mall, an apartment complex, an airport terminal, a train station, a bus station, a stadium, a museum, etc.) often have multiple entry-exit points and paths thereto with different aids (e.g., ramps or elevators for users in wheelchairs) and/or obstacles (e.g., stairways for the same users in wheelchairs) in terms of physical accessibility. A user with a disability is likely to have a difficult time deciding which of the possibilities is the most convenient as the ride hailing pick up point and a path thereto given the user's location, especially in locations that are unfamiliar to the user.

In one example use case, a user on a wheelchair may want to book a ride hailing vehicle (e.g., a cab) using a ride hailing service application on the user's device (e.g., a mobile phone or smartphone) while shopping at a mall. In this example, the user may be finished or close to being finished shopping and wants to minimize the travelling and wait time to get home with the user's purchases. For example, an entry-exit point may appear close to the user on the map (i.e., appears as a promising potential pickup point), but in fact is on a different floor of the mall from the user thus requires taking an escalator on an opposite side of the building, or the entry-exit point may be inaccessible to a wheelchair (e.g., a fire exit).

As a result, the user might waste time and effort to get to the fire exit then turn around for another exit, while a driver of a ride hailing vehicle may have to waste time and fuel driving around looking for the user. In some instances, a driver may have to pull over or even park the vehicle to contact the user (e.g., via phone or text) causing additional delay and inconvenience. Further, inaccurate localization may cause a ride hailing system or operator to inaccurately switch pickup assignments among nearby ride hailing vehicles. In each instance, the user frustration and the pickup wait time are unnecessarily increased, causing inconvenience for both users and operators.

In addition, users with different types and severity levels of disabilities require different kinds and degrees of supporting for ride-booking with user devices, for identifying users/vehicles, as well as for entering vehicles. By way of example, in addition to the existing voice command for ride-booking by a blind user, and a vehicle with a wheelchair ramp for a user on a wheelchair, etc., other software and/or hardware improvements can be provided for different types and severity levels of disabilities.

To address these technical problems, a system 100 of FIG. 1 introduces a capability to provide a ride-hailing/ride-booking service based on user disability data, according to one embodiment. In one embodiment, the system 100 provides for a comprehensive ride booking experience tailored to the specific disability associated with a potential user. For example, the system 100 can provide a booking application user interface that provides touch-based user interface for selecting ride locations that leverages personal user mobility data indicating the most frequently or recently visited locations to reduce the burden associated with entering locations into the booking application.

In one embodiment, after specifying the desired location or destination, the system 100 provides mean for navigating or routing the disabled or physically-challenged user to the nearest and most easily accessible location from where the user can get into the booked vehicle based on the user's disability data. For example, the system 100 can create a correlation between map features (e.g., required ranges of path widths, curb heights, presence of nearby structures, presence of location aids such sound beacons, etc.) and different disabilities (e.g., wheelchair bound, blind, hearing impaired, etc.). The correlation of map feature parameters that are most suited to a given disability/physical condition can then be used to select or recommended pick-up and/or drop-off locations in proximity to a user based on the user's specific disability. For example, a first pick-up location may be nearer to a user in a wheelchair but requires traveling up a stairway (e.g., as indicated in the map data of the area). As a result, the system 100 would recommend a second pick-up location that might be further away but is more accessible via a ramp because the system 100 has previously recorded a correlation that a disability requiring a wheelchair prefers a path or location that is accessible via a ramp instead of a stairway.

In one embodiment, another component of providing a ride-hailing service based on disability data includes providing an approach for easy identification of the booked ride-hailing vehicle, the user, and/or the driver of the vehicle. For example, the system 100 can initiate a signaling between devices of the driver/vehicle and the user as the vehicle is approaching the pick-up point. The signaling, for instance, can include but is not limited to flashing lights on a configured smart stick (e.g., for blind users) in unique pattern/color, flashing lights on a configured wheelchair in a unique pattern/color (e.g., for wheelchair-bound users), and/or the like depending on a given disability.

In one embodiment, the system 100 of FIG. 1 may include one or more user equipment (UE) 101a-101n (also collectively referred to herein as UEs 101) (e.g., a mobile device, a smartphone, etc.) associated with a user 103. In one embodiment, the UEs 101 include one or more device sensors 105a-105n (also collectively referred to herein as device sensors 105) (e.g., GPS sensors) and one or more applications 107a-107n (also collectively referred to applications 107) having connectivity to a routing platform 109 via a communication network 111.

In one embodiment, the system 100 determines that a user 103 is searching for a ride hailing service (e.g., to go home while inside a POI 113) via an application 107 (e.g., a mapping application, a ride hailing booking or reservation application, etc.). By way of example, a POI 113 in this instance is a POI that has several entry-exit points 113a-113n (e.g., an apartment complex, a shopping mall, an airport terminal, a stadium, a museum, a hospital, etc.) such that a user 103 may likely be challenged to know which exit-entry point is the most convenient for designating as the ride hailing pickup point relative to the user's current location (e.g., exit 113a).

In one instance, the ride hailing service includes one or more vehicles 115a-115n (also collectively referred to as vehicles 115) (e.g., a cab) that are configured with one or more vehicle sensors 117a-117n (also collectively referred to as vehicle sensors 117) and have connectivity to the routing platform 109 via the communication network 111. In one embodiment, the vehicles 115 are standard transport vehicles (e.g., cars, vans, trucks, etc.) that can be used to transport users. In one instance, the vehicles 115 are autonomous or semi-autonomous transport vehicles that can sense their environments and navigate without driver or occupant input via the vehicle sensors 117. Although the vehicles 115 are depicted as automobiles, it is contemplated that the vehicles 115 may be any type of transportation capable of picking up and transporting a user between any two points, such as an electric vehicle in an airport terminal.

In one embodiment, one or more user equipment (UE) 102a-102n (also collectively referred to herein as UEs 102) (e.g., a mobile device, a smartphone, etc.) are associated with vehicles 115. By way of example, the UEs 102 include one or more device sensors 104a-104n (also collectively referred to herein as device sensors 104) (e.g., GPS sensors) and one or more applications 108a-108n (also collectively referred to applications 108) having connectivity to the routing platform 109 via the communication network 111.

In one embodiment, the system 100 determines disability information (e.g., disability type and/or severity) associated with a user, and map feature parameters based on the disability information (e.g., an elevator, a wheelchair ramp or lift in place of stairs). The system 100 then selects a ride hailing (pick-up and/or drop-off) location by comparing map feature data of candidate ride hailing (pick-up and/or drop-off) locations and/or related paths against the map feature parameters, and provides the selected ride hailing (pick-up and/or drop-off) location and a related path as an output.

In another embodiment, the system 100 calculates a cost function for routing to the ride hailing location for the user 103 from the user's location within the POI 113 to access the one or more entry-exit points of the POI (e.g., exits 113a-113n) so that the user 103 may access a ride hailing vehicle 115 (e.g., vehicle 115a) at the designated pickup point 119. In one instance, the system 100 calculates the path based on information including user disability type(s), disability severity, disability aids used by the user (e.g., smart wheelchairs, ultrasonic blind sticks or smart glasses, etc.), user preferences (e.g., travelling distance threshold(s), mode(s) of transport, etc.), indoor map data, historic human traffic data within the POI 113, etc. In one embodiment, the system 100 prompts the user 103 to provide the information. In another embodiment, the system 100 retrieves the information from data stored in or accessible via a geographic database (e.g., the geographic database 121). In yet another embodiment, the system 100 monitors user mobility patterns to detect the information. By way of example, the system 100 uses artificial intelligence, machine learning, etc. to determine that the user 103 travels on a wheelchair.

In one instance, the system 100 can render or show the user 103 (e.g., via a mapping application 107) the exit of the POI 113 (e.g., exit 113a) that will require the user 103 to take the least effort and/or time to reach the exit and the pickup point 119 from the user's current location. In one embodiment, the system 100 can also provide the user guidance (e.g., step-by-step guidance) via an application 107 (e.g., a mapping application) so that the user 103 can proceed through the POI 113 entry-exit point (e.g., exit 113a) to the ride hide hailing pick up point 119 and be picked up by the ride hailing vehicle 115 (e.g., vehicle 115a) without any hassle or delay.

In one embodiment, the system 100 can also share or transmit the recommended pickup point to a ride hailing vehicle 115 (e.g., vehicle 115a). In one instance, the system 100 can provide the recommended pickup point 119 via a UE 101 (e.g., a mobile device) associated with the driver of the vehicle 115 or via a UE 101 such an embedded navigation system. By sharing the recommended pickup point 119 to a ride hailing service operator and/or nearby ride hailing vehicles 115, it is contemplated that the system 100 can also reduce pickup wait times for operators attempting to reach user pickup points (e.g., pickup point 119), which can improve fuel consumption and costs and facilitate greater operational convenience.

In one embodiment, the system 100 can also provide data for establishing a communication connection between a UE 101a of the user 103 and a UE 102a associated with the vehicle 115a and/or a driver of the vehicle 115a based on detecting that the user device 101a and the vehicle device 102a (and/or the vehicle 115a) are within a proximity threshold. The system 100 signals a user identity to the vehicle device 102a using the communication connection, as well as signals a vehicle identity of the vehicle 115a and/or a driver identity of the driver using the communication connection, so the user 103 and the driver can identify each other, such as by color of clothes, color and/model of the vehicle, etc. In another embodiment, the user device can be an aid device configured to provide an indication of the user identity, such as a smart stick, a wheelchair, etc. In addition, the user and the driver can ask for more or update information, such as any room in the vehicle trunk, a new wait location of the vehicle due to traffic control, a user delay, one additional passenger (e.g., another user with disabilities wanting to share the ride, a nurse or assistant of the user, etc.), etc.

In another embodiment, the system 100 determines a mapping between a map feature parameter and a disability, stores the mapping in a geographic database, and provides access to the geographic database to a ride booking service to calculate a pick-up location, a drop-off location, or a combination for a user based on user disability information and the mapping. The map feature parameter specifies a threshold value of a physical characteristic of a map feature associated with a person affected with the disability. By way of example, the map feature includes a road slope, a curb height, or a combination thereof. As another example, the map feature includes a presence of a physical structure, an obstacle, or a combination thereof. In addition, the system 100 determines a location of a user of the ride booking service and calculates a first route from the location to the pick-up location, a second route from the drop-off location to a destination, or a combination thereof based on the disability information and the geographic database.

In another embodiment, the system 100 selects a pick-up location, a drop-off location, or a combination thereof for a user of a ride booking service by comparing map feature data queried from a geographic database of one or more candidate pick-up locations, one or more candidate drop-off locations, or a combination thereof against disability information associated with the user, provides data for establishing a communication connection between a user device of the user and a vehicle device of a vehicle of the ride booking service, and initiates a signaling between the user device and the vehicle device based on determining that the user, the vehicle, or a combination thereof is within a proximity threshold of the pick-up location, the drop-off location, or a combination thereof. In one embodiment, the user device is an aid device configured provide an indication of the user identity as part of the signaling. By way of example, the aid device includes at least one of a smart stick and a wheelchair. In one embodiment, the aid device is further configured to present data indicating a first route from a location of the user to the pick-up location, a second route from the drop-off location to a destination, or a combination thereof. In addition, the system 100 dynamically updates the pick-up location, the drop-off location, or a combination thereof based on real-time map data queried from the geographic database.

Although the various embodiments are discussed with respect to a point of interest, it is contemplated that the approaches described herein are applicable to any location recorded in a map database. By way of example, the user may be located at a riverbank which has only GPS coordinates yet without any point of interest tag. Nevertheless, the geographic database 121 has trail data of the riverbank, such as a road slope/gradian, a curb height, a curve geometry, a sidewalk divider, a tree, etc., for the system 100 to select a ride hailing location for the user.

In addition, although the various embodiments are discussed with respect to a pick-up location, it is contemplated that the approaches described herein are applicable to a drop-off location, as well as the whole ride. By way of example, the user 103 books a ride from the mall back to the user's apartment complex with multiped entries/exits. The system 100 can calculate a cost function for routing to the apartment unit for the user 103 for a candidate drop-off location in the apartment complex that will take the least effort and/or time. In another embodiment, the system 100 can calculate a cost function for a combination of pick-up and drop-off locations that will take the least effort and/or time.

Moreover, although the various embodiments are discussed with respect to ride-hailing services, it is contemplated that the approaches described herein are applicable to ride-sharing services (e.g., commercial ride-sharing, peer-to-peer carpooling, slugging, hitchhiking, etc.), public transportation connecting services for people with disabilities, etc.

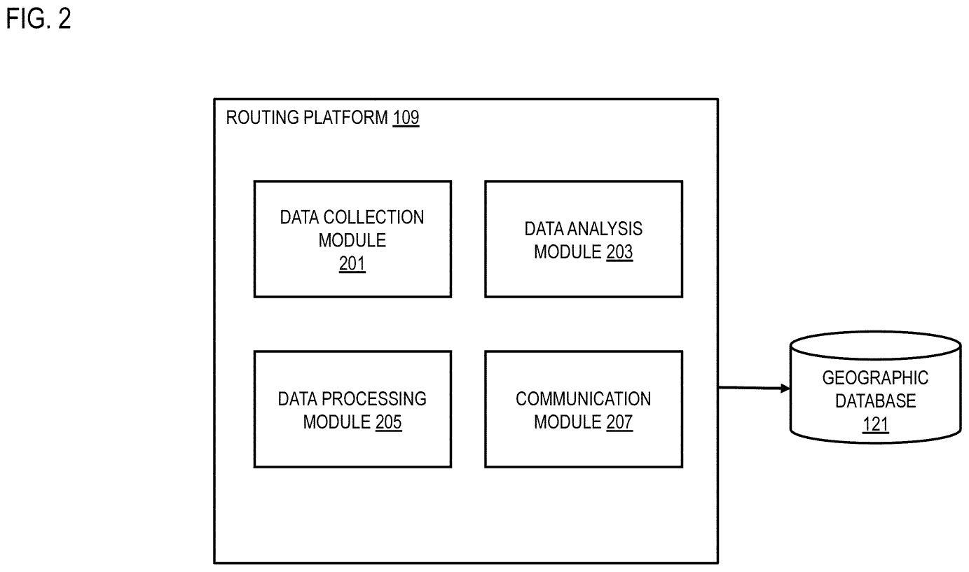

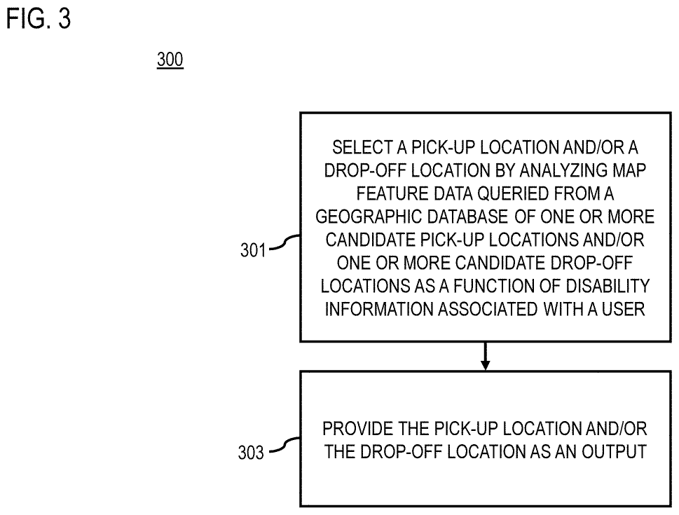

FIG. 2 is a diagram of the components of the routing platform 109, according to one embodiment. By way of example, the routing platform 109 includes one or more components for determining a ride hailing point (e.g., at a POI) based on map data corelated with user disabilities. It is contemplated that the functions of these components may be combined in one or more components or performed by other components of equivalent functionality. In one embodiment, the routing platform 109 includes a data collection module 201, a data analysis module 203, a data processing module 205, and a communication module 207, with connectivity to the geographic database 121. The above presented modules and components of the routing platform 109 can be implemented in hardware, firmware, software, or a combination thereof. Though depicted as separate entities in FIG. 1, it is contemplated that the routing platform 109 may be implemented as a module of any of the components of the system 100. In another embodiment, the routing platform 109 and/or one or more of the modules 201-207 may be implemented as a cloud-based service, local service, native application, or combination thereof. The functions of the routing platform 109 and/or the modules 201-207 are discussed with respect to FIGS. 3-5 below.

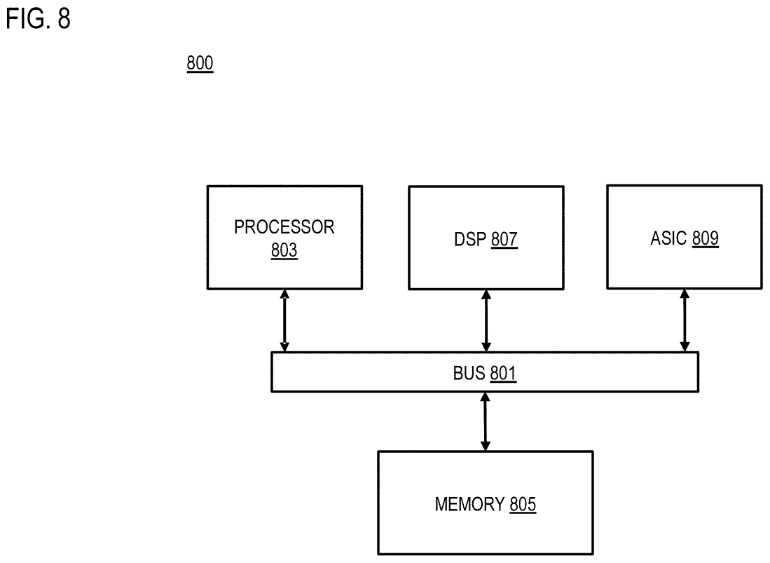

FIG. 3 is a flowchart of a process for providing a ride-hailing/ride-booking service based on user disability data, according to one embodiment. In various embodiments, the routing platform 109 and/or the modules 201-207 may perform one or more portions of the process 300 and may be implemented in, for instance, a chip set including a processor and a memory as shown in FIG. 8. As such, the routing platform 109 and/or modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the data processing module 205 selects a pick-up location, a drop-off location, or a combination thereof by analyzing map feature data queried from a geographic database of one or more candidate pick-up locations, one or more candidate drop-off locations, or a combination thereof as a function of disability information associated with a user. By way of example, the data processing module 205 selects the pick-up location, the drop-off location, or a combination thereof by comparing the map feature data queried from a geographic database (e.g., the geographic database 121) of one or more candidate pick-up locations, one or more candidate drop-off locations, or a combination thereof against one or more map feature parameters.

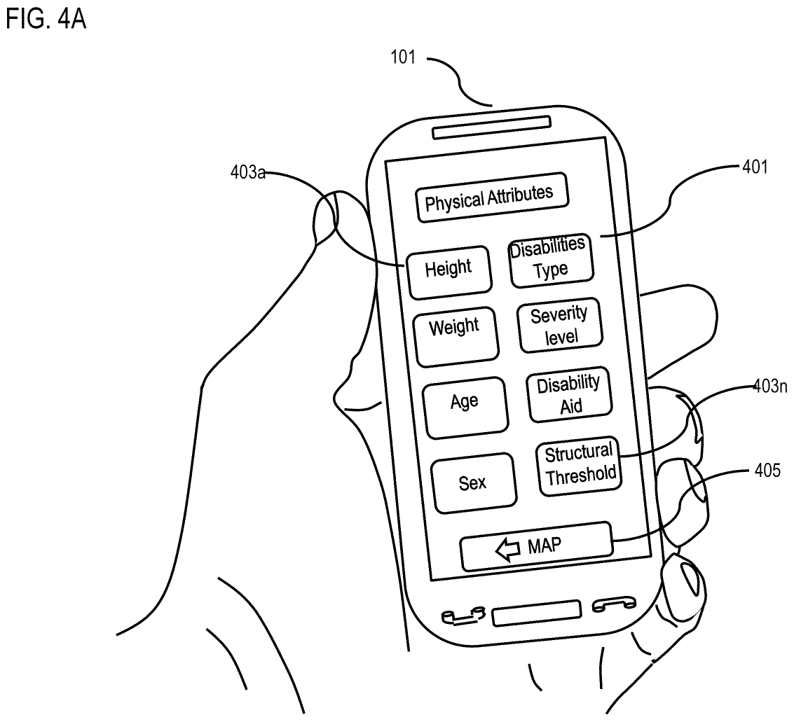

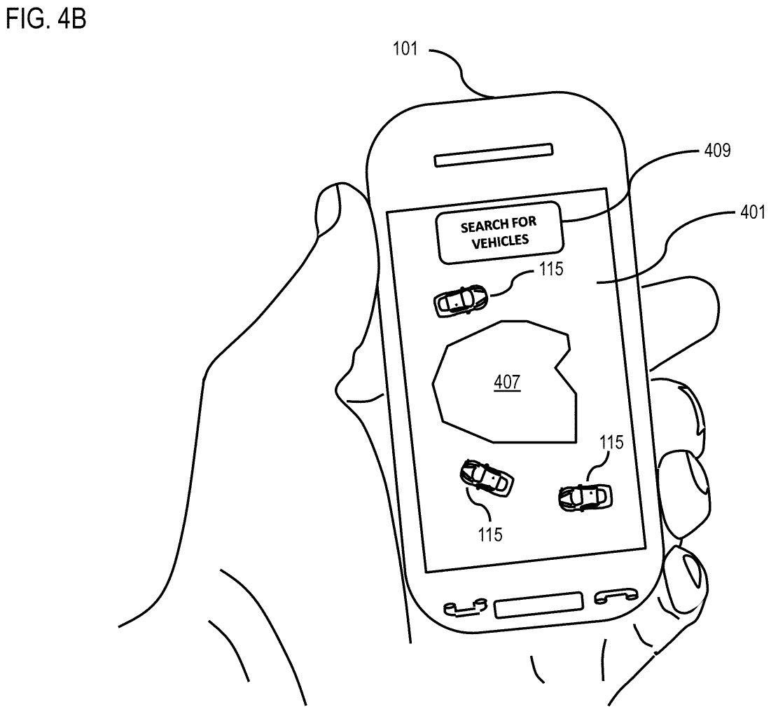

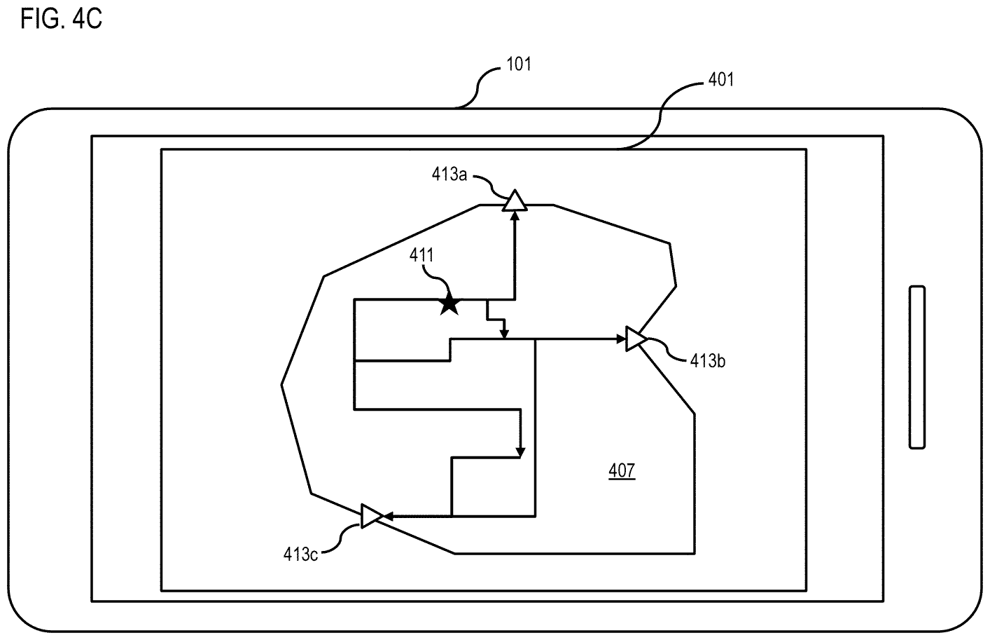

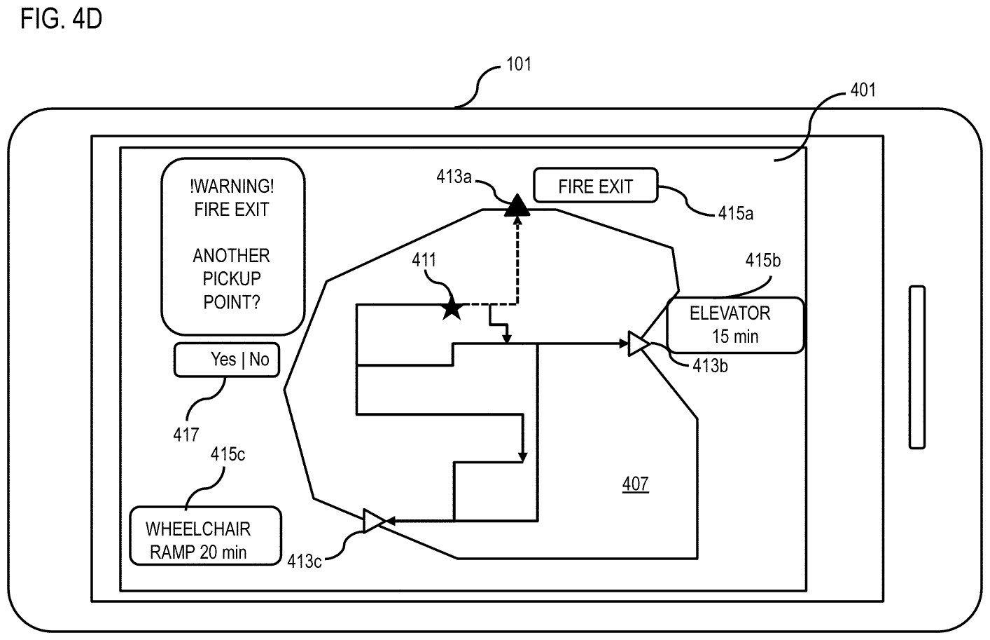

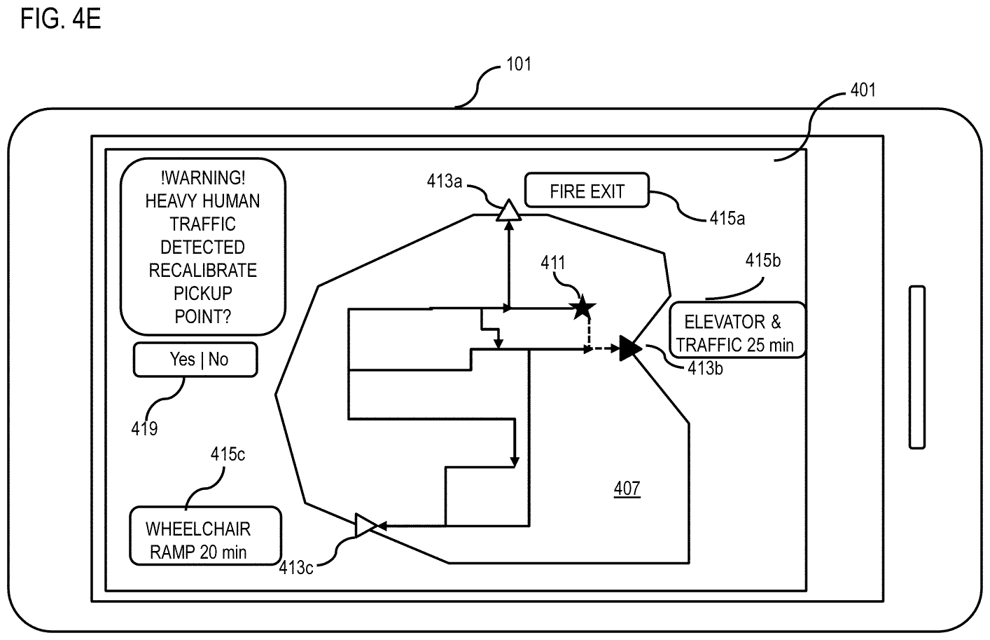

In one embodiment, the data collection module 201 determines the disability information associated with the user. FIGS. 4A through 4E are diagrams of example location-based user interfaces for providing a ride-hailing/ride-booking service based on user disability data, according to one embodiment. In one embodiment, the data collection module 201 can generate the UI 401 such that a user can input or enter physical attribute information based on buttons 403a-403n once she or he has initiated the search for a ride hailing service, as depicted in FIG. 4A. In one embodiment, the UI 401 includes a map button 405 to enable the user to return to a map portion of the UI 401 once the one or more physical attributes (e.g., height, weight, age, sex, disability type, disability severity, disability aid, traveling distance threshold, etc.) of the user 103 have been entered via the UI 401.

In another embodiment, the data collection module 201 collects user mobility pattern data via UE 101a, the vehicle 115a, or a combination thereof, for the data analysis module 203 to determine the one or more physical attributes (e.g., height, weight, age, sex, disability type, disability severity, disability aid, traveling distance threshold, etc.) of the user 103, using artificial intelligence, machine learning, etc.

In another embodiment, the data collection module 201 extracts the one or more physical attributes (e.g., height, weight, age, sex, disability type, disability severity, disability aid, a traveling distance threshold, etc.) of the user 103 from public entity records (e.g., medical records, school records, social benefit records, etc.), user profile data, user communication channels (e.g., emails, chats, instant messages, social media posts, photos, product/service purchase data, etc.), etc.

Many types of disabilities can affect user access to a ride hailing service, such as mobility impairments, visual impairments, hearing impairments, communication disorders, a learning disability or impairment in mental functioning, etc. Mobility impairment includes physical defects, and damage to one or multiple organs of the body. Visual impairment includes minor to various serious vision injuries or impairments. Hearing impairment includes a partial or total inability to hear. A communication disorder is any disorder that affects an individual's ability to comprehend, detect, or apply language and speech to engage in discourse effectively with others. Learning disability is a condition in the brain that causes difficulties comprehending or processing information. Each type of disability requires a different kind of accommodations and/or supports for ride booking, traveling to a ride hailing location, identifying the vehicle/driver, and entering the vehicle. A disability severity level of the user also affects the user's access to a ride hailing service, such as a degree of blindness affect the user's ability to identify a ride hailing service vehicle.

As to disability aids, they can assist the user in every steps of the ride hailing service. By way of example, a smart wheelchair can be loaded on a left easily to get up or down in-between floors, and also to be loaded into a taxi easily. As another example, an ultrasonic blind stick can help a completely blind person to avoid obstacles (e.g., trees, road blocks, pedestrians, animals, etc.) on the way to/from the ride-hailing location, as well as to provide an indication of the user identity (e.g., emitting color blinks for the driver to see, transmitting Bluetooth signal to communicate with a device of the driver, etc.) at/near the ride hailing location. Regarding a traveling distance threshold, it can be conditioned on user preferences, user disability limitation, etc.

In one embodiment, the data analysis module 203 determines the one or more map feature parameters based on the disability information. In one embodiment, the one or more map feature parameters specify one or more physical characteristics associated with a person affected by a disability indicated in the disability information. By way of examples, a road slop and a curb height on a sidewalk affect a user on a wheelchair.

The data processing module 205 determines a location of a user of a ride hailing service. In one embodiment, the data processing module 205 can determine the location of the user based on a position (e.g., latitudinal/longitudinal coordinates, GPS coordinates, etc.) of a UE 101 (e.g., a mobile device, a smartphone, etc.) associated with the user. In one instance, the data processing module 205 can determine the position of a UE 101 based on one or more wireless connections. For example, the wireless connection may be between a UE 101 and one or more wireless fidelity (WiFi) routers positioned throughout a POI; between a UE 101 and one or more GPS satellites (e.g., satellites 123); or between a UE 101 and one or more other UEs 101 within a POI at a given time (i.e., an ad hoc peer-to-peer network). In one embodiment, where one or more wireless connections may be temporarily unavailable (e.g., the user is near or obstructed by a “blind” spot), the data processing module 205 can determine the position of a UE 101 based one or more live maps (e.g., associated with an application 107) stored on the UE 101. By way of example, the data processing module 205 may determine the location of the user based on an initiation of a search for a ride hailing service using an application 107 (e.g., a mapping application, a routing application, a ride hailing booking or reservation application, or a combination thereof).

In one embodiment, the data processing module 205 can further determine that the user is located inside a POI. In this instance, a POI refers to a large structure that has more than one entry-exit point that is accessible by a ride hailing service (e.g., an apartment complex, an airport terminal, a shopping mall, a stadium, etc.). Further, a user is likely to be uncertain while inside the POI as to which entry-exit would be the most convenient for designating as the ride hailing pickup point. In one embodiment, the data processing module 205 can determine that the user is located inside a POI by comparing the position of the UE 101 (e.g., GPS coordinates) against any known POI coordinates that are stored in or accessible via the geographic database 121.

In one instance, the data processing module 205 determines at least one entry-exit point of the POI. By way of example, the data collection module 201 can determine the number and/or location of each entry-exit point of the POI based on information or data relative to the POI stored in or accessible via the geographic database 121 (e.g., indoor maps, external imagery such as photographs, satellite images, etc., or a combination thereof).

In one embodiment, the map feature data relate to one or more physical characteristics of the one or more candidate pick-up locations, the one or more candidate drop-off locations, or a combination thereof. The one or more physical characteristics relate to a physical accessibility. In one embodiment, the one or more physical characteristics relate to a presence of a physical structure within a threshold distance. By way of example, the presence of the physical structure provides for an echolocation by the user. Blind people can use passive and active echolocation to learn about their environments via perceiving echoes from nearby objects, so as to avoid obstacles and/or seeking accessibility. In this case, a blind person generates mouth clicks and speculates locations, dimensions, densities, etc. of objects (e.g., pedestrians, trees, overhangs, walls, doorways, poles, curbs and steps, fire hydrants, parked or moving vehicles, etc.) using the echoes from the clicks.

In another embodiment, the one or more map feature parameters specify one or more thresholds for the one or more physical characteristics associated with a person affected by a disability indicated in the disability information. By way of examples, a road slope of 5-10 degrees and a curb height of 1-2 inches on a sidewalk are accessible for a user on a manual wheelchair, while a road slope of 5-25 degrees and a curb height of 1-4 inches on a sidewalk are accessible for a user on a powered wheelchair.

In one embodiment, the data analysis module 203 constructs a correlation table/matrix among map feature parameters versus all physical attributes (e.g., height, weight, age, sex, disability type, disability severity, disability aid, a traveling distance threshold, etc.). In another embodiment, the data analysis module 203 constructs a correlation table/matrix among map feature parameters versus disability attributes (e.g., disability type, disability severity, disability aid, structural thresholds, etc.) as shown in Table 1. Such correlation table/matrix can be constructed for a group of users or personalized for a specific user.

TABLE 1

| | Disability | | | |
|---|---|---|---|---|
| Disability | Severity | Disability | Structural | |
| Type | 1-10 | Aid | Thresholds | . . . |

| | | | | |
|---|---|---|---|---|
| Ramp | Mobility | 7 | Wheelchair | 1:12 ramp |
| Sloop | | | | slope ratio |
| Curb | Mobility | 7 | Wheelchair | 1-2 inches |
| Height | | | | |
| Tactile | Visual | 9 | White | Raised & flat- |
| Ground | | | Cane | topped bars of |
| Surface | | | | 5.5 mm high, |
| Indicators | | | | 35 mm wide, |
| for | | | | spaced 45 |
| guiding | | | | mm apart |
| . . . | | | | |

In another embodiment, the data processing module 205 calculates a cost function (including parameter such as distance, user travel efficiency, etc.) for routing to candidate ride hailing locations from the user's current location so that the user 103 may access a ride hailing vehicle 115 (e.g., vehicle 115a) at the designated pickup point 119 with least effort and time. In another embodiment, the a cost function further includes parameter such as user preferences (e.g., comfort levels, vehicle models, vehicle accessibilities, etc.), user context (e.g., appointments, schedules, etc.), traffic (e.g., pedestrian traffic), weather, events (e.g., a parade, an accident, etc.) en route to a candidate ride hailing location, etc. In other embodiments, the data processing module 205 and/or the user can assign and/or vary weighting factors to different cost parameters for different purposes.

In one embodiment, the data processing module 205 dynamically updates the pick-up location, the drop-off location, or a combination thereof based on real-time map data queried from the geographic database 121. By way of example, the data processing module 205 re-calculates a ride hailing pickup point at a POI based on a change in user context or traffic, according to one embodiment.

In this example, the data collection module 201 determines a level of pedestrian traffic within a POI, a level of vehicular traffic proximate to the POI, or a combination thereof, wherein the data processing module 205 calculates the user path and/or vehicle route further with respect to the traffic. In one embodiment, the data collection module 201 can determine the levels of pedestrian traffic and vehicular traffic based on historic information, patterns, or data sets stored in or accessible via the geographic database 121. In another instance, the data collection module 201 can determine the levels based on location data (e.g., GPS data) associated with a UE 101 (e.g., a mobile device, an embedded navigation system, etc.). By way of example, there may be multiple users walking through a POI with access to or using a UE 101 (e.g., a mobile phone or a smartphone). In addition, in instances where a ride hailing vehicle 115 does not have an embedded navigation system, the driver of the vehicle 115 may still have access to or be using a UE 101 (e.g., a mobile phone or a smartphone). In one embodiment, the data collection module 201 can determine that the pedestrian traffic within the POI is indicative of congestion and may adversely affect the estimated number of steps to be taken by the user to reach the pickup point, potentially causing both the user and the ride hailing service operator inconvenience and delay. Similarly, the data collection module 201 can determine that the vehicular traffic proximate to the POI is indicative of congestion and may adversely affect the ride hailing vehicle 115′s estimated arrival time at the ride hailing pickup point, potentially causing both the user and the ride hailing service operator inconvenience and delay. Consequently, in one embodiment, the data processing module 205 can calculate or recalculate in real-time or substantially real-time the user path from the location to the pickup point for the ride hailing service based on the traffic.

In another example, the data analysis module 203 may determine based on location data (e.g., GPS data) derived from a UE 101 that a user is travelling towards a ride hailing pickup point but then for some reason (intentional or unintentional) decides to travel in another direction. For example, a user in airport terminal may intentionally decide to change the path to use a restroom before being picked up. Alternatively, the same user may be talking on the user's mobile device and unintentionally changes the path without noticing. Consequently, in one embodiment, the data processing module 205 can calculate or recalculate in real-time or substantially real-time the path from the location to the pickup point for the ride hailing service based on the change. In one instance, wherein the disparity between the estimated number of aids (e.g., tactile ground surface indicators for the blind) and/or obstacles (e.g., increasing pedestrian traffic, a popup holiday market on the sidewalk, etc.) exceeds a certain threshold, the data processing module 205 can calculate or recalculate in real-time or substantially real-time the path from the location to the pickup point for the ride hailing service based on the disparity. As a result of changing ride-hailing location, the data processing module 205 may decide whether to wait or to move on to another pickup location and/or another ride hailing service operator (i.e., a new ride hailing service vehicle 115) to minimize delay and inconvenience.

On the ride hailing service side, the data processing module 205 can calculate or recalculate in real-time or substantially real-time the path from the vehicle location to the pickup point for the a ride hailing service operator (e.g., a driver), so as to decide whether to wait or to move on to another pickup, or a ride hailing service operator can decide whether to assign a new ride hailing service vehicle 115 to the pickup to minimize delay and inconvenience.

In step 303, the communication module 207 provides the pick-up location, the drop-off location, or a combination thereof as an output to a user device of the user, a vehicle picking up or dropping off the user, a ride booking service, or a combination thereof. In one embodiment, the communication module 207 provides the representation in a user interface of a ride hailing service. By way of example, the user interface may be an application 107 (e.g., a mapping application, a navigation application, a ride hailing service booking or reservation application, etc.) of a UE 101 (e.g., a mobile device, an embedded navigation system, etc.). In one instance, a user inside of the POI (e.g., a shopping mall) may view the representation via a mobile device (e.g., a smartphone) and/or a driver of a ride hailing vehicle may view the representation via a mobile device, embedded navigation system, or a combination thereof. In one embodiment, the representation includes the path, the recommended entry-exit point, the estimated number of steps, an estimated arrival time, or a combination thereof.

By way of example, the representation may let the user know that the recommended entry-exit point will take the user approximately 20 minutes to reach and, therefore, the user should select a ride hailing vehicle 115 (if more than one vehicle 115 is available) that is likely to be at the corresponding pickup point within that time frame. At or about the same time, the representation may let a ride hailing service (e.g., an operator or a driver) know that a user is approximately 20 minutes away from the ride hailing pickup point. In one instance, the operator can then assign a ride hailing service vehicle 115 that is the best position to pick up the user at that time (e.g., with minimal wait and/or inconvenience) or the driver of a ride hailing vehicle 115 may individually decide to pick up the user much like a traditional taxi approach.

FIGS. 4B through 4E are diagrams of example location-based user interfaces for determining a ride hailing pickup point at a POI that minimizes wait time based on map data corelated with user disabilities, according to one embodiment. In this example, the location-based UI 401 (e.g., a ride hailing booking or reservation application) is generated for a UE 101 (e.g., a mobile device) that can assist a user with disabilities to book a ride hailing vehicle 115 (e.g., a driven cab or an autonomous taxi) to take them from the POI 407 (e.g., a shopping mall) home. For example, the user on a wheelchair may have multiple shopping bags and, therefore, could benefit from the convenience of being driven home as opposed to taking public transportation. At the same time, the user also wants to avoid waiting too long at a POI entry-exit point.

Referring to FIG. 4B, in one embodiment, the UI 401 includes a button 409 (e.g., “search for vehicles”) to initiate a search for a ride hailing service and/or one or more ride hailing vehicles 115 (e.g., driven taxis and/or autonomous vehicles) in the vicinity of the POI 407. As described above, in many instances, the user on a wheelchair may not be familiar with the POI and/or may not be certain as to where the entry-exits points of the POI are located, or more importantly, which one of the one or more entry-exit points of the POI the user should designate as the ride hailing pickup point to minimize the user's wait time before being picked up by a ride hailing vehicle 115.

In one embodiment, the data collection module 201 first determines the location of the user (e.g., represented by the symbol 411) relative to the entry-exit points of the POI 407 (e.g., points 413a, 413b, and 413c) based on the initiation of the search for a ride hailing service, as depicted in FIG. 4C. In this instance, the distances between the user's location 411 and the entry-exit points 413a and 413b may appear nominal to a user whereas the distance between the user's location 411 and the entry-exit point 413c appears to the user substantially further and/or inconvenient to reach in a short period of time.

In one embodiment, the data processing module 205 then considers the user disability information and accessibility between the location 411 and the entry-exit points 413a-413c to determine an optimal pick-up location. In one instance, the data processing module 205 can determine the optimal pick-up location by comparing map feature data (e.g., indoor map information) queried from a geographic database of candidate pick-up locations against map feature parameters and/or user data (e.g., physical attributes including disability type, severity, aids, distance threshold, etc.). In another embodiment, the data processing module 205 can determine the optimal pick-up location further based on real-time or substantially real-time location data (e.g., GPS data), traffic data, etc.

For example, in some situations, it may appear to a user on a wheelchair which entry-exit point is closer to the user. However, in other instances, such as in the case of entry-exit points 413a and 413b, the data processing module 205 may access historical probe data (e.g., stored in the geographic database 121) or real-time or substantially real time location data associated with a UE 101 (e.g., a mobile device). By way of example, the data processing module 205 can determine that based on real-time or historic location data that while the paths between the user's location 411 and the entry-exit points 413a and 413b appear nearly the same, and the entry-exit point 413c is farther away. By way of example, the user designates one of the entry-exit point 413a as the ride hailing pickup point, as depicted in FIG. 4D. In this instance, the data processing module 205 temporarily designates the entry-exit point 413a as the ride hailing pickup point by modifying the route or path between the user's location 411 and the entry-exit point 413a and by shading the entry-exit symbol 413a.

In one embodiment, the data processing module 205 can also provide the accessibility information, an estimated arrival time, or a combination thereof, as depicted in the windows 415a, 415b, and 415c. In this example, the data processing module 205 determines and presents the entry-exit point 413a as a fire exit (thus not an option for the user) in the window 415a, the entry-exit point 413b as passing via an elevator and 15 minutes from the user location 411 on a wheelchair in the window 415b, and the entry-exit point 413c as passing via a wheelchair ramp and 20 minutes from the user location 411 on a wheelchair in the window 415c.

In one embodiment, a user can interact with the windows 415 to learn or to change the information that the data processing module 205 is using to determine the optimal pickup point. For example, by default, the data processing module 205 may determine the optimal pickup point based on historic user mobility data, but the user has learned over the course of time that she or he is considerably slower or faster than the such averages and, therefore, may want to set the data processing module 205 to determine the optimal pickup point based on the user's own mobility data and/or preference data (e.g., preferring wheelchair ramps over elevators). In one embodiment, the communication module 207 can then share or transmit the ride hailing pickup point (e.g., point 413a) generally with one or more ride hailing services or directly with one or more ride hailing vehicles 115 within the vicinity of the POI 407 to optimize both the user wait time and any possible wait times on the part of the one or more ride hailing vehicles 115. In this example, the data processing module 205 can visually prompt or notify the user of the point 413a is a fire exit via the UI 401 (e.g., “Warning! Fire Exit. Another pickup Point?”) in a popup window 417, as depicted in FIG. 4D. In one instance, the data processing module 205 may also cause the UI 101 to vibrate or make a sound to alert the user of the warning.

In one instance, a user can respond to the prompt through an interaction with an input (e.g., a touch, a gesture, a voice command, etc.). When the user selects No, the data processing module 205 can continue the warning and/or suggest other options or continue with the designated route. When the user selects Yes, the data processing module 205 designates the entry-exit point 413b as the ride hailing pickup point by modifying the route or path between the user's location 411 and the entry-exit point 413b and by shading the entry-exit symbol 413b in FIG. 4E, since it takes shorter time to reach the entry-exit point 413b than the entry-exit point 413c.

In one embodiment, the data processing module 205 can present the accessibility information and estimated arrival time to the user via the UI 401. Further, in one instance, the data processing module 205 extracts map data from the geographic database 121 to navigate step-by-step navigation instructions to guide the user via the elevator to the entry-exit point 413b in a manner appendicle for the user. The navigation instructions can be displayed on the UI 401, when the user is not blind. The navigation instructions can be played via speakers of the UE 101, when the user is not deaf.

In another embodiment, the data processing module 205 can convert the navigation instructions to be readable by a disability aid of the user, such as a smart cane or a smart wheelchair, and the communication module 207 transmits the converted navigation instructions to the disability aid of the user, in order to direct the user to the entry-exit point 413b.

In addition, the communication module 207 can share or transmit the ride hailing pickup point (e.g., 413b) to the one or more ride hailing vehicles 115 so that the ride hailing service operator can decide which vehicle to assign for the pickup and estimates the pickup time.

In terms of identifying the vehicle and/or the user, the communication module 207 can initiate a short-range wireless connection (e.g., Bluetooth, ZigBee, infrared, etc.) search from the UE 101a and from the UE 102a with the driver of the vehicle 115, once the parties are within the threshold distance. Once the two devices come in vicinity, the broadcasted signals get synced, and the devices are connected to identify each other. In another embodiment, the communication module 207 can initiate human and/or machine apprehensible visual signals (e.g., color blinks) and/or audio signals (e.g., sounds, music, noise, etc.) on the devices, the disability aids (e.g., a smart cane or wheelchair), etc. for identifying the user and/or the vehicle. This is especially helpful when multiple users are waiting for rides.

In one embodiment, the data collection module 201 can determine a change in the accessibility information based on location data (e.g., GPS data) associated with the UE 101. For example, the data collection module 201 can determine that human traffic increases on the path to the entry-exit point 413b, and that the data processing module 205 estimated it will take the user 25 minutes to reach the entry-exit point 413b on a wheelchair. In this instance, the data processing module 205 updates the window 415b corresponding to the entry-exit point 413b as passing via an elevator with human traffic and 25 minutes from the user location 407 on a wheelchair in the window 415b.

In one embodiment, the data processing module 205 can visually prompt or notify the user of the change via the UI 401 (e.g., “Warning! Heavy Human Traffic Detected. Another pickup Point?”) in a popup window 419, as depicted in FIG. 4E. In one instance, the data processing module 205 may also cause the UI 101 to vibrate or make a sound to alert the user of the warning.

When the user selects No, the data processing module 205 can continue the warning and/or suggest other options or continue with the designated route. When the user selects Yes, the data processing module 205 designates the entry-exit point 413c as the ride hailing pickup point by modifying the route or path between the user's location 411 and the entry-exit point 413c and by shading the entry-exit symbol 413c, since it takes shorter time to reach the entry-exit point 413c than the entry-exit point 413b.

In one embodiment, the data processing module 205 can present the updated accessibility information and estimated arrival time to the user via the UI 401. Further, in one instance, the communication module 207 can share or transmit the new ride hailing pickup point (e.g., 413c) to the one or more ride hailing vehicles 115 previously contacted so that the ride hailing service operator can decide whether to wait based on the new ride hailing pickup point, the new estimated arrival time, or a combination thereof or whether to move on to another pickup. In one embodiment, wherein the disparity between the estimated arrival times exceeds a certain threshold (e.g., 5-10 minutes), the communication module 207 can share or transmit the new ride hailing pickup point 413c with a new batch of one or more ride hailing service vehicles 115 (e.g., if the original vehicles 115 are no longer in the vicinity).

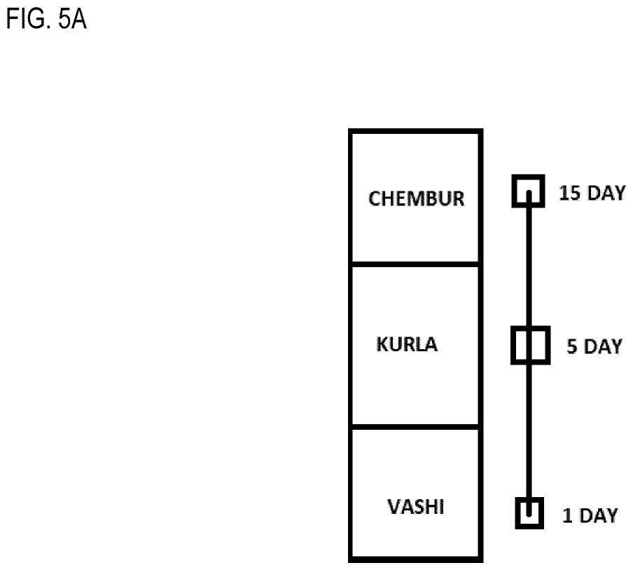

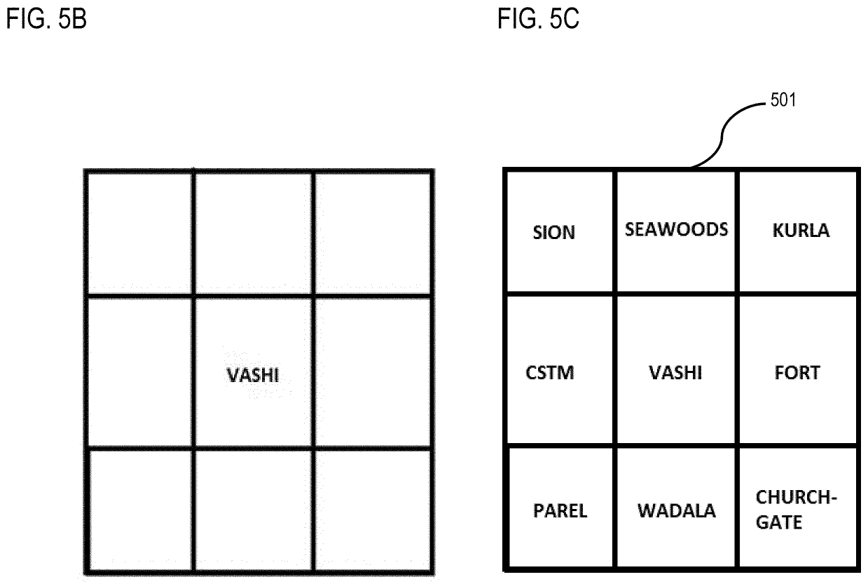

FIGS. 5A through 5C are diagrams of example location-based user interfaces for supporting ride-booking for a blind and mute person, according to one embodiment. In one instance, the system 100 can identify the user based on biometric verification, such as fingerprints, hand geometry, earlobe geometry, retina and iris patterns, voice waves, DNA, signatures, etc. By way of example, the system 100 detects a touch of the user on the UE 101a, and identifies the user based on the pressure of the touch, a gap between one nail and muscle, etc. After the user is identified, the system 100 retrieves his/her last 15 days travel history in the city of Mumbai. FIG. 5A shows that the user visited from Vashi on day one to Kurla until day five, then to Chembur until day fifteen.

In one embodiment, the system shows a grid with the most recently area Vashi in the center as in FIG. 5B, and then populates with areas nearby Vashi for the user to select an area to travel next as in FIG. 5C. When a UI 501 senses a finger of the user touching a cell in the center, the UE 101a generates a sound saying VASHI. If the user intends to select other places, then the user can keep moving the finger for other options. However, if none of the nine areas in FIG. 5C is selected by the user, the system moves on the earlier visited area Kurla, and updates the grid using Kurla as the center accordingly, for the user to select from. The same process repeats until the user selects a next destination. In another embodiment, the system 101 supports the blind and mute user to communicate with braille on the keys of UE 101a, to select the next destination. In yet another embodiment, if the user is deaf and mute, the system 101 supports the user to communicate with gestures, sign language, etc., to select the next destination.

The above-described embodiments provide autonomy and safety for users with disabilities, so they can independently hail a vehicle without assistance from other people. The above-described embodiments also provide ease and efficiency for the drivers of ride hailing services to complete a smooth ride. As such, the volume of ridership increases.

Returning to FIG. 1, in one embodiment, the UEs 101 can be associated with any user within or nearby a POI that is accessible to a ride hailing service (e.g., a cab), or with any user or person within a vehicle 115 (e.g., a driver or a passenger of an autonomous or semi-autonomous vehicle). By way of example, the UEs 101 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 101 can support any type of interface to the user (such as “wearable” circuitry, etc.). In one embodiment, the vehicles 115 may have cellular or wireless fidelity (Wi-Fi) connection either through the inbuilt communication equipment or from a UE 101 associated with the vehicles 115. Also, the UEs 101 may be configured to access the communication network 111 by way of any known or still developing communication protocols. In one embodiment, the UEs 101 may include the routing platform 109 to provide a ride-hailing/ride-booking service based on user disability data.

In one embodiment, the UEs 101 include device sensors 105 (e.g., a front facing camera, a rear facing camera, GPS sensors, multi-axial accelerometers, height sensors, tilt sensors, moisture sensors, pressure sensors, wireless network sensors, etc.) and applications 107 (e.g., mapping applications, ride hailing booking or reservation applications, routing applications, guidance applications, navigation applications, etc.). In one example embodiment, the GPS sensors 105 can enable the UEs 101 to obtain geographic coordinates from satellites 123 for determining current or live location and time (e.g., within a POI). Further, a user location within a POI may be determined by a triangulation system such as A-GPS, Cell of Origin, or other location extrapolation technologies when cellular or network signals are available. In one embodiment, the location of the UEs 101 can be determined within a POI based on one or more WiFi routers positioned throughout the POI.

In one embodiment, the routing platform 109 performs the process for providing a ride-hailing/ride-booking service based on user disability data as discussed with respect to the various embodiments described herein. In one embodiment, the routing platform 109 can be a standalone server or a component of another device with connectivity to the communication network 111. For example, the component can be part of an edge computing network where remote computing devices (not shown) are installed along or within proximity of an intended destination (e.g., a city center).

In one embodiment, the routing platform 109 has connectivity over the communication network 111 to the services platform 125 (e.g., an OEM platform) that provides one or more services 127a-127n (also collectively referred to herein as services 127) (e.g., mapping/routing services). By way of example, the services 127 may also be other third-party services and include mapping services, navigation services, ride hailing reservation or booking services (e.g., booking a ride hailing vehicle 115), guidance services, notification services, social networking services, content (e.g., audio, video, images, etc.) provisioning services, application services, storage services, contextual information determination services, location-based services, information-based services (e.g., weather, news, etc.), etc. In one instance, the services 127 provide representations of each user (e.g., a profile), his/her social links, and a variety of additional information (e.g., one or more physical attributes). In one instance, the services 127 can allow users to share location information, activities information, POI related information, contextual information, and interests within their individual networks, and provides for data portability.

In one embodiment, the content providers 129a-129n (also collectively referred to herein as content providers 129) may provide content or data (e.g., navigation-based content such as destination information, routing instructions, estimated times of arrival, POI related data such as indoor maps and entry-exit points, historical human traffic data; ride hailing service booking or contact information; etc.) to the UEs 101, the applications 107, the routing platform 109, the vehicles 115, the geographic database 121, the services platform 125, and the services 127. The content provided may be any type of content, such as map content, contextual content, audio content, video content, image content (e.g., exterior images of a POI), etc. In one embodiment, the content providers 129 may also store content associated with the UEs 101, the applications 107, the routing platform 109, the vehicles 115, the geographic database 121, the services platform 125, and/or the services 127. In another embodiment, the content providers 129 may manage access to a central repository of data, and offer a consistent, standard interface to data, such as a repository of the geographic database 121.

By way of example, as previously stated the vehicle sensors 117 may be any type of sensor. In certain embodiments, the vehicle sensors 117 may include, for example, a GPS sensor for gathering location data, a network detection sensor for detecting wireless signals or receivers for different short-range communications (e.g., Bluetooth, Wi-Fi, light fidelity (Li-Fi), near field communication (NFC) etc.), temporal information sensors, a camera/imaging sensor for gathering image data, velocity sensors, and the like. In another embodiment, the vehicle sensors 117 may include sensors (e.g., mounted along a perimeter of the vehicle 115) to detect the relative distance of the vehicle 115 from lanes or roadways, the presence of other vehicles 115, pedestrians, animals, traffic lights, road features (e.g., curves) and any other objects, or a combination thereof. In one scenario, the vehicle sensors 117 may detect weather data, traffic information, or a combination thereof. In one example embodiment, the vehicles 115 may include GPS receivers 117 to obtain geographic coordinates from satellites 123 for determining current or live location and time. Further, the location can be determined by a triangulation system such as A-GPS, Cell of Origin, or other location extrapolation technologies when cellular or network signals are available.

The communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the routing platform 109 may be a platform with multiple interconnected components. By way of example, the routing platform 109 may include multiple servers, intelligent networking devices, computing devices, components and corresponding software for providing a ride-hailing/ride-booking service based on user disability data. In addition, it is noted that the routing platform 109 may be a separate entity of the system 100, a part of the services platform 125, the services 127, or the content providers 129.

In one embodiment, the geographic database 121 stores information regarding indoor map information, historic human traffic data, or a combination thereof associated with a POI. In one instance, the geographic database 121 also stores information regarding one or more physical attributes, average walking data (e.g., a mobility graph), or a combination thereof of a user of a user device (e.g., a mobile phone, a smartphone, a pair of smart glasses, etc.). In one embodiment, the geographic database 121 stores data associated with vehicular traffic proximate to a POI, ride hailing service booking and/or contact information, etc. The information may be any of multiple types of information that can provide means for providing a ride-hailing/ride-booking service based on user disability data. In another embodiment, the geographic database 121 may be in a cloud and/or in a UE 101, a vehicle 115, or a combination thereof.

By way of example, the UEs 101, the applications 107, the routing platform 109, the vehicles 115, the geographic database 121, the satellites 123, the services platform 125, the services 127, and the content providers 129 communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

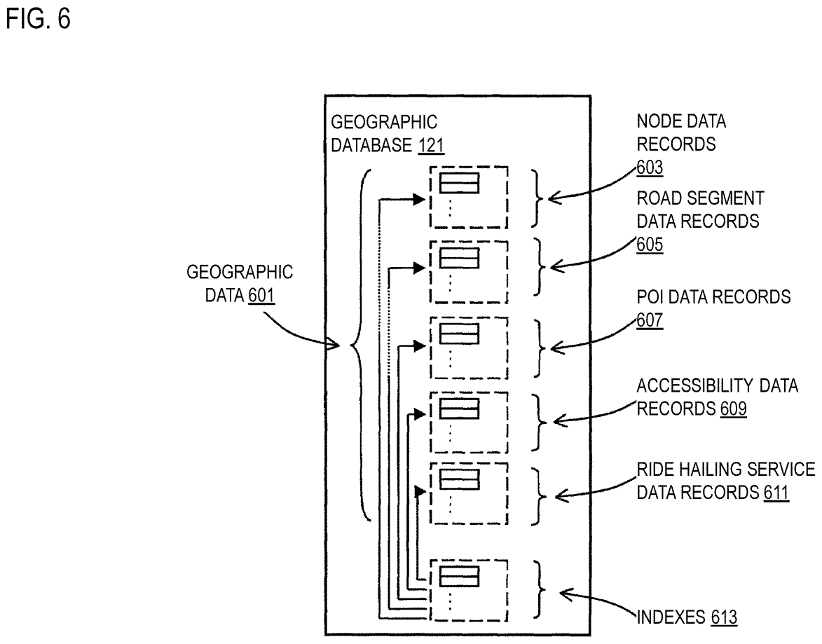

FIG. 6 is a diagram of a geographic database 121, according to one embodiment. In one embodiment, geographic database 121 includes geographic data 601 used for (or configured to be compiled to be used for) mapping and/or navigation-related services, such as for step counting to access a POI pickup point, video odometry based on mapped features, e.g., lane lines, road markings, signs, etc.

In one embodiment, geographic features, e.g., two-dimensional or three-dimensional features, are represented using polygons, e.g., two-dimensional features, or polygon extrusions, e.g., three-dimensional features. For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in geographic database 121.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes, e.g., used to alter a shape of the link without defining new nodes.

“Oriented link”—A link that has a starting node (referred to as the “reference node”) and an ending node (referred to as the “non-reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary, e.g., a hole or island. In one embodiment, a polygon is constructed from one outer simple polygon and none or at least one inner simple polygon. A polygon is simple if it just consists of one simple polygon, or complex if it has at least one inner simple polygon.

In one embodiment, the geographic database 121 follows certain conventions. For example, links do not cross themselves and do not cross each other except at a node. Also, there are no duplicated shape points, nodes, or links. Two links that connect each other have a common node. In geographic database 121, overlapping geographic features are represented by overlapping polygons. When polygons overlap, the boundary of one polygon crosses the boundary of the other polygon. In geographic database 121, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 121 includes node data records 603, road segment or link data records 605, POI data records 607, accessibility data records 609, ride hailing service data records 611, and indexes 613, for example. More, fewer or different data records can be provided. In one embodiment, additional data records (not shown) can include cartographic (“carto”) data records, routing data, and maneuver data. In one instance, the additional data records (not shown) can include user mobility pattern data. In one embodiment, the indexes 613 may improve the speed of data retrieval operations in geographic database 121. In one embodiment, the indexes 613 may be used to quickly locate data without having to search every row in geographic database 121 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes, an estimated time of arrival, or a combination thereof (e.g., an estimated time of arrival of a ride hailing vehicle 115 at a POI pickup point). The node data records 603 are end points corresponding to the respective links or segments of the road segment data records 605. The road link data records 605 and the node data records 603 represent a road network, such as used by vehicles, cars, and/or other entities. Alternatively, the geographic database 121 can contain path segment and node data records or other data that represent pedestrian paths, bicycle paths, or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 121 can include data about the POIs and their respective locations in the POI data records 607. In one instance, the POI data records 607 can include indoor map information, entry-exit point information (e.g., numbers and locations of entry-exit points), historic pedestrian traffic flows within the POI, historic vehicular traffic flows proximate to the POI, opening and closing times of a POI, etc.

In one embodiment, the indoor map information is created from high-resolution 3D mesh or point-cloud data generated, for instance, from LiDAR. The 3D mesh or point-cloud data are processed to create 3D representations of interior pathways, hallways, corridors, etc. of a POI at centimeter-level accuracy for storage in the POI data records 607.

In one embodiment, the geographic database 121 can also include accessibility data records 609. By way of example, the accessibility data records 609 may include a correlation table/matrix among map feature parameters versus all physical attributes (e.g., height, weight, age, sex, disability type, disability severity, disability aid, a traveling distance threshold, etc.). In another embodiment, the accessibility data records 609 may include a correlation table/matrix among map feature parameters versus disability attributes (e.g., disability type, disability severity, disability aid, a traveling distance threshold, etc.). Such correlation table/matrix can be constructed for a group of users, or personalized for a specific user.

In one embodiment, the geographic database 121 can also include ride hailing service data records 611. In another embodiment, the ride hailing service data records 611 stores information relating to the one or more ride hailing services, one or more ride hailing vehicles, e.g., vehicle type, vehicle features, reservation cost information, etc. By way of example, the ride hailing services data records 611 can be associated with one or more of the node data records 603, road segment data records 605, and/or POI data records 607 to support localization and opportunistic use of the ride hailing services during navigation through a POI.

In one embodiment, geographic database 121 can be maintained by a content provider 129 in association with the services platform 125, e.g., a map developer. The map developer can collect geographic data to generate and enhance geographic database 121. There can be different ways used by the map developer to collect data. These ways can include obtaining data from other sources, such as municipalities or respective geographic authorities. In addition, the map developer can employ field personnel to travel by foot with a UE 101 within various large POIs to determine step counting information or records about them, for example. Also, remote sensing, such as aerial or satellite photography, can be used for approximating interior distances (e.g., using one or more satellites 123).

The geographic database 121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, a UE 101, for example. The navigation-related functions can correspond to pedestrian navigation, vehicle navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing a ride-hailing/ride-booking service based on user disability data may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

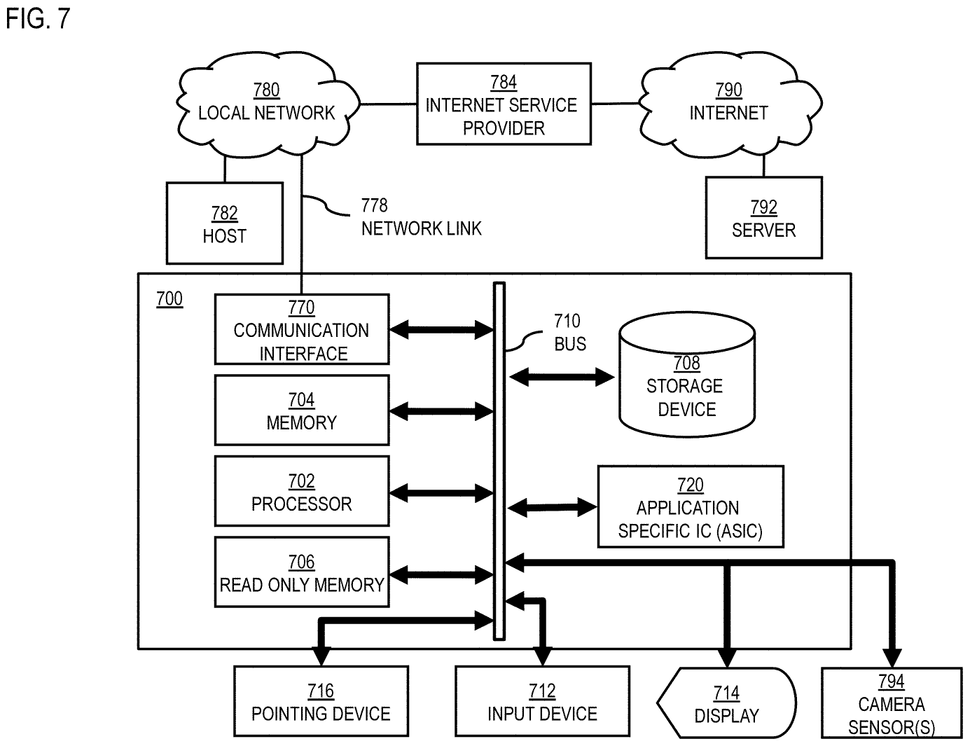

FIG. 7 illustrates a computer system 700 upon which an embodiment of the invention may be implemented. Computer system 700 is programmed (e.g., via computer program code or instructions) to provide a ride-hailing/ride-booking service based on user disability data as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to providing a ride-hailing/ride-booking service based on user disability data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random-access memory (RAM) or other dynamic storage device, stores information including processor instructions for providing a ride-hailing/ride-booking service based on user disability data. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing a ride-hailing/ride-booking service based on user disability data, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general, the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 111 for providing a ride-hailing/ride-booking service based on user disability data.

The term non-transitory computer-readable medium is used herein to refer to any medium that participates in providing information to processor 702, including instructions for execution. Such a medium may take many forms, including, but not limited to, non-volatile media, volatile media and transmission media. Non-volatile or non-transitory media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

In one embodiment, a non-transitory computer-readable storage medium carrying one or more sequences of one or more instructions (e.g., computer code) which, when executed by one or more processors (e.g., a processor as described in FIG. 5), cause an apparatus (e.g., the vehicles 101, the UEs 105, the routing platform 109, etc.) to perform any steps of the various embodiments of the methods described herein.

FIG. 8 illustrates a chip set 800 upon which an embodiment of the invention may be implemented. Chip set 800 is programmed to provide a ride-hailing/ride-booking service based on user disability data as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide a ride-hailing/ride-booking service based on user disability data. The memory 805 also stores the data associated with or generated by the execution of the inventive steps.

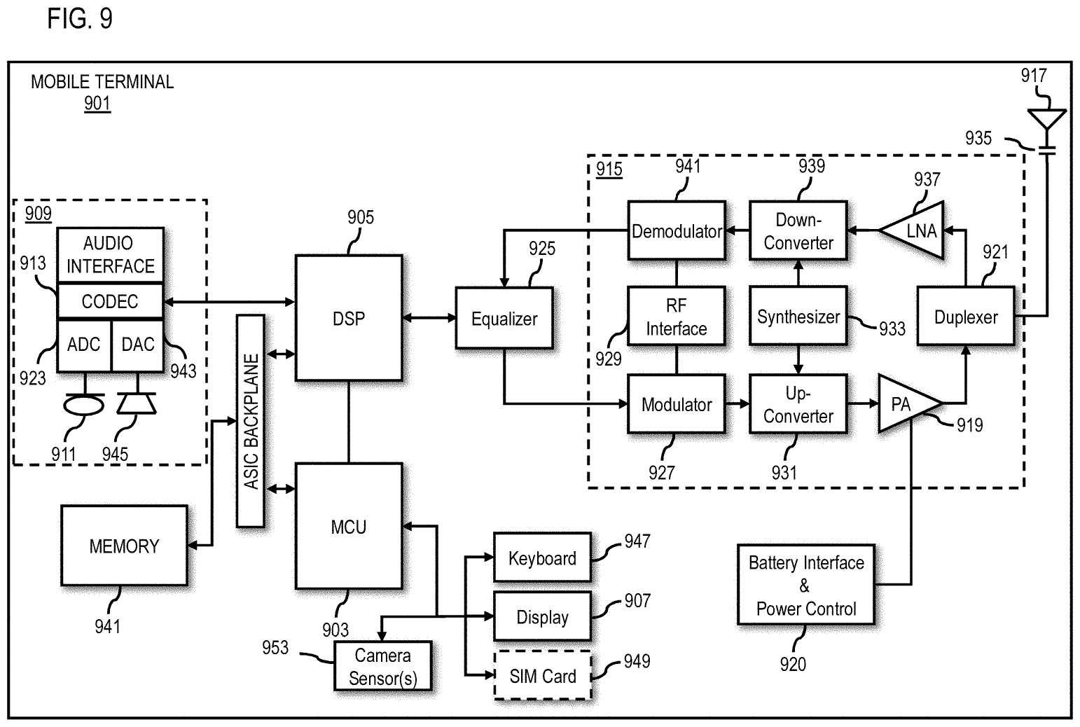

FIG. 9 is a diagram of exemplary components of a mobile terminal 901 (e.g., handset or vehicle or device/parts thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and the user's voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to provide a ride-hailing/ride-booking service based on user disability data. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
selecting a pick-up location, a drop-off location, or a combination thereof by analyzing map feature data queried from a geographic database of one or more candidate pick-up locations, one or more candidate drop-off locations, or a combination thereof as a function of disability information associated with a user; and
providing the pick-up location, the drop-off location, or a combination thereof as an output to a user device of the user, a vehicle picking up or dropping off the user, a ride booking service, or a combination thereof.

2. The method of claim 1, further comprising:
determining the disability information associated with the user; and
determining one or more map feature parameters based on the disability information,
wherein the map feature data queried from the geographic database is analyzed via comparing the map feature data queried from the geographic database against the one or more map feature parameters, and
wherein the map feature data relate to one or more physical characteristics of the one or more candidate pick-up locations, the one or more candidate drop-off locations, or a combination thereof, and wherein the one or more map feature parameters specify one or more thresholds for the one or more physical characteristics associated with a person affected by a disability indicated in the disability information.

3. The method of claim 2, wherein the one or more physical characteristics relate to a physical accessibility.

4. The method of claim 2, wherein the one or more physical characteristics relate to a presence of a physical structure within a threshold distance.

5. The method of claim 4, wherein the presence of the physical structure provides for an echolocation by the user.

6. The method of claim 1, further comprising:
determining a disability type, a disability severity, or a combination thereof based on the disability information,
wherein the one or more map feature parameters are further based on the disability type, the disability severity, or a combination thereof

7. The method of claim 1, further comprising:
providing data for establishing a communication connection between the user device of the user and a vehicle device associated with the vehicle, a driver of the vehicle, or a combination thereof based on detecting that the user device and the vehicle device are within a proximity threshold.

8. The method of claim 7, further comprising at least one of:
signaling a user identity to the vehicle device using the communication connection;
signaling a vehicle identity of the vehicle, a driver identity of the driver, or a combination thereof using the communication connection.

9. The method of claim 8, wherein the user device is an aid device configured to provide an indication of the user identity.

10. The method of claim 1, wherein the pick-up location, the drop-off location, or a combination thereof is further based on user historical mobility information.

11. An apparatus comprising:
at least one processor; and
at least one memory including computer program code for one or more programs,
the at least one memory and the computer program code configured to, with the at least one processor, cause the apparatus to perform at least the following,
determine a mapping between a map feature parameter and a disability;
store the mapping in a geographic database; and
provide access to the geographic database to a ride booking service to calculate a pick-up location, a drop-off location, or a combination for a user based on user disability information and the mapping.

12. The apparatus of claim 11, wherein the map feature parameter specifies a threshold value of a physical characteristic of a map feature associated with a person affected with the disability.

13. The apparatus of claim 12, wherein the map feature includes a road slope, a curb height, or a combination thereof.

14. The apparatus of claim 12, wherein the map feature includes a presence of a physical structure, an obstacle, or a combination thereof.

15. The apparatus of claim 11, wherein the apparatus is further caused to:
determine a location of a user of the ride booking service; and
calculate a first route from the location to the pick-up location, a second route from the drop-off location to a destination, or a combination thereof based on the disability information and the geographic database.

16. A non-transitory computer-readable storage medium carrying one or more sequences of one or more instructions which, when executed by one or more processors, cause an apparatus to at least perform the following steps:
selecting a pick-up location, a drop-off location, or a combination thereof for a user of a ride booking service by comparing map feature data queried from a geographic database of one or more candidate pick-up locations, one or more candidate drop-off locations, or a combination thereof against disability information associated with the user;
providing data for establishing a communication connection between a user device of the user and a vehicle device of a vehicle of the ride booking service; and
initiating a signaling between the user device and the vehicle device based on determining that the user, the vehicle, or a combination thereof is within a proximity threshold of the pick-up location, the drop-off location, or a combination thereof.

17. The non-transitory computer-readable storage medium of claim 16, wherein the user device is an aid device configured provide an indication of the user identity as part of the signaling.

18. The non-transitory computer-readable storage medium of claim 17, wherein the aid device includes at least one of a smart stick and a wheelchair.

19. The non-transitory computer-readable storage medium of claim 17, wherein the aid device is further configured to present data indicating a first route from a location of the user to the pick-up location, a second route from the drop-off location to a destination, or a combination thereof.

20. The non-transitory computer-readable storage medium of claim 16, wherein the apparatus is caused to further perform:
dynamically updating the pick-up location, the drop-off location, or a combination thereof based on real-time map data queried from the geographic database.
